(19) United States
(12) Patent Application Publication
(10) Pub. No.: US 2026/0203279 A1
(43) Pub. Date: Jul. 16, 2026

(54) TRANSFORMING NATURAL LINGUISTIC DESCRIPTIONS INTO DATABASE STATEMENTS WITH A TARGETED APPROACH

(71) Applicant: Dell Products L.P., Round Rock, TX (US)

(72) Inventors: Vivek Bhargava, Bangalore (IN); Mahender Allam, Ghanpur (IN); Dinesh Koppada, Bengaluru (IN); Furkan Mohd Nisar, Ambedkar Nagar (IN)

(73) Assignee: Dell Products L.P., Round Rock, TX (US)

(21) Appl. No.: 19/023,818

(22) Filed: Jan. 16, 2025

(51) Int. Cl. G06F 16/242; G06F 40/205; G06F 40/284; G06F 40/295; G06F 40/30

(52) U.S. Cl. CPC G06F 16/243; G06F 40/205; G06F 40/284; G06F 40/295; G06F 40/30

(57) ABSTRACT

Methods, system, and non-transitory processor-readable storage medium for a SQL query generation system are provided herein. An example method includes tokenizing a natural language query into separate words using natural language processing, performing part-of-speech tagging on the tokenized words to identify grammatical categories, identifying named entities and keywords within the natural language query, analyzing syntax and word relationships to determine dependencies between words in the query, identifying user intent for data retrieval, insertion, deletion, or updates based on the analyzed syntax and word relationships and keywords, accessing metadata associated with database tables, identifying relevant database tables using metadata-based tags that categorize the database tables, generating a structured query language (SQL) statement based on the identified user intent, the analyzed syntax and word relationships, the identified database tables, and metadata relationships, and executing the generated SQL statement to retrieve results from the database.

### FIELD

The field relates generally to writing SQL queries, and in particular retrieving data from database(s), within information processing systems.

### BACKGROUND

The demand for efficient data retrieval and manipulation has increased in various industries due to today's technology-driven landscape. However, writing Structured Query Language (SQL) queries requires technical expertise and a deep understanding of database structures. A beginner faces challenges in crafting accurate queries due to lack of technical expertise, lack of knowledge and understanding of databases, and huge datasets.

### SUMMARY

Illustrative embodiments provide techniques for implementing a SQL query generation system in a storage system. For example, illustrative embodiments comprise the structured query language (SQL) query generation system tokenizing a natural language query into separate words using natural language processing. The SQL query generation system performs part-of-speech tagging on the tokenized words to identify grammatical categories and identifies named entities and keywords within the natural language query. The SQL query generation system analyzes syntax and word relationships to determine dependencies between words in the query and identifies user intent for data retrieval, insertion, deletion, or updates based on the analyzed syntax and word relationships and keywords. The SQL query generation system accesses metadata associated with database tables, where a database comprises the database tables and identifies relevant database tables using metadata-based tags that categorize the database tables. The SQL query generation system generates a structured query language (SQL) statement based on the identified user intent, the analyzed syntax and word relationships, the identified database tables, and metadata relationships and executes the generated SQL statement to retrieve results from the database. Other types of processing devices can be used in other embodiments. These and other illustrative embodiments include, without limitation, apparatus, systems, methods and processor-readable storage media. These and other illustrative embodiments include, without limitation, apparatus, systems, methods and processor-readable storage media.

### BRIEF DESCRIPTION OF THE DRAWINGS

FIG. 1 shows an information processing system including a SQL query generation system, in an illustrative embodiment.

FIG. 2 shows a flow diagram of a process for a SQL query generation system, in an illustrative embodiment.

FIG. 3 shows the data sets for both “Employee Assets” and Employee Details “, in an illustrative embodiment.

FIG. 4 shows the metadata for Employee Assets, in an illustrative embodiment.

FIG. 5 shows the metadata for Employee Details, in an illustrative embodiment.

FIG. 6 shows annotated training data for both “Employee Assets” and Employee Details” data sets, in an illustrative embodiment.

FIG. 7 trains the spaCy NER model using the combined annotated training data, in an illustrative embodiment.

FIG. 8 shows using the trained model, in an illustrative embodiment.

FIG. 9 illustrates example software code that imports a spaCy English model, in an illustrative embodiment.

FIG. 10 illustrates example code for SQL query generation, in an illustrative embodiment.

FIG. 11 illustrates an example usage of the code from FIG. 10, and the generated SQL query, in an illustrative embodiment.

FIGS. 12 and 13 show examples of processing platforms that may be utilized to implement at least a portion of a SQL query generation system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a SQL query generation system, which technique may be used to simplify SQL query generation for users without technical expertise or deep understanding of databases, thereby empowering the users to interact with databases efficiently, making data resources more accessible and enhancing usability. The structured query language (SQL) query generation system tokenizes a natural language query into separate words using natural language processing. The SQL query generation system performs part-of-speech tagging on the tokenized words to identify grammatical categories and identifies named entities and keywords within the natural language query. The SQL query generation system analyzes syntax and word relationships to determine dependencies between words in the query and identifies user intent for data retrieval, insertion, deletion, or updates based on the analyzed syntax and word relationships and keywords. The SQL query generation system accesses metadata associated with database tables, where a database comprises the database tables and identifies relevant database tables using metadata-based tags that categorize the database tables. The SQL query generation system generates a structured query language (SQL) statement based on the identified user intent, the analyzed syntax and word relationships, the identified database tables, and metadata relationships and executes the generated SQL statement to retrieve results from the database. Other types of processing devices can be used in other embodiments. These and other illustrative embodiments include, without limitation, apparatus, systems, methods and processor-readable storage media.

Conventional technologies limit users from independently retrieving data from databases since SQL queries are complex, requiring technical competence and programming skills. Conventional technologies require users to have the technical expertise of, for example, a database administer, to use a SQL generation tool designed specifically for a database management system. Conventional technologies do not allow users to express queries in a natural language. These users, therefore, cannot use existing SQL generation tools and cannot communicate with databases in an efficient manner. If these users lack SQL experience, they are unable to identify the correct database tables, database columns, and conditions for their query. Even if users have a rudimentary knowledge of SQL, they still may be limited by the complexity of their queries and the technically demanding process, especially when interacting with large datasets. Conventional technologies that require users to create SQL queries are inefficient, and can lead to errors since creating SQL queries manually requires an effort of close attention to syntax and structure. Conventional technologies use SQL interfaces that leverage predefined patterns or templates that encounter difficulties with complex language.

By contrast, in at least some implementations in accordance with the current technique as described herein, SQL query generation is automated to allow users without technical expertise or deep understanding of databases to interact with databases efficiently by a structured query language (SQL) query generation system that tokenizes a natural language query into separate words using natural language processing. The SQL query generation system performs part-of-speech tagging on the tokenized words to identify grammatical categories and identifies named entities and keywords within the natural language query. The SQL query generation system analyzes syntax and word relationships to determine dependencies between words in the query and identifies user intent for data retrieval, insertion, deletion, or updates based on the analyzed syntax and word relationships and keywords. The SQL query generation system accesses metadata associated with database tables, where a database comprises the database tables and identifies relevant database tables using metadata-based tags that categorize the database tables. The SQL query generation system generates a structured query language (SQL) statement based on the identified user intent, the analyzed syntax and word relationships, the identified database tables, and metadata relationships and executes the generated SQL statement to retrieve results from the database.

Thus, a goal of the current technique is to provide a method and a system for a SQL query generation system that can automatically translate simple language requirements into efficient SQL queries for data retrieval from databases, simplifying the process and enabling users to obtain the desired results. Another goal is to provide a user-friendly interface, making it easier for users with different levels of technical expertise, allowing non-technical users to interact with specific datasets, using various database operations. Another goal is to allow non-SQL experts to extract data from databases, connecting users with different backgrounds to improve their interaction with databases. Another goal is to enable diverse employees to interact with databases to diversity the workforce and reduce reliance on a small, specialized group. Another goal is to provide metadata-driven query generation to enable flexibility in adapting to changes in database structures. Another goal is to provide metadata-driven query generation, enabling users to interact with database tables based on the associated metadata. Another goal is to identify and classify datasets, helping users choose specific datasets accurately. Another goal is to utilize the structure and properties of the database tables rather than solely relying on translating user intent into fixed query templates, offering a more intelligent and flexible solution. Another goal is to combine natural language with SQL translation, generating queries based on metadata and using tags to identify datasets. Yet another goal is to provide a system that bridges the gap between technical and non-technical users, making data extraction more user-friendly and efficient.

In at least some implementations in accordance with the current technique described herein, the use of a SQL query generation system can provide one or more of the following advantages: automatically translate simple language requirements into efficient SQL queries for data retrieval from databases, provide a user-friendly interface allowing non-technical users to interact with specific datasets to use various database operations, enable diverse employees to interact with databases to diversity the workforce, reducing reliance on a small, specialized group, provide metadata-driven query generation to enable flexibility in adapting to changes in database structures, enabling users to interact with database tables based on the associated metadata, combine natural language with SQL translation, generating queries based on metadata and using tags to identify datasets, and provide a system that bridges the gap between technical and non-technical users, making data extraction more user-friendly and efficient.

In contrast to conventional technologies, in at least some implementations in accordance with the current technique as described herein, simple language requirements are automatically translated into efficient SQL queries for data retrieval from databases. The structured query language (SQL) query generation system tokenizes a natural language query into separate words using natural language processing. The SQL query generation system performs part-of-speech tagging on the tokenized words to identify grammatical categories and identifies named entities and keywords within the natural language query. The SQL query generation system analyzes syntax and word relationships to determine dependencies between words in the query and identifies user intent for data retrieval, insertion, deletion, or updates based on the analyzed syntax and word relationships and keywords. The SQL query generation system accesses metadata associated with database tables, where a database comprises the database tables and identifies relevant database tables using metadata-based tags that categorize the database tables. The SQL query generation system generates a structured query language (SQL) statement based on the identified user intent, the analyzed syntax and word relationships, the identified database tables, and metadata relationships and executes the generated SQL statement to retrieve results from the database.

In an example embodiment of the current technique, the SQL query generation system tracks versioning and changes in the metadata to maintain data modification history.

In an example embodiment of the current technique, the SQL query generation system automatically predicts and assigns labels to new tables based on content associated with the new tables.

In an example embodiment of the current technique, the SQL query generation system standardizes metadata labels for consistent categorization in the database.

In an example embodiment of the current technique, the SQL query generation system creates annotated training data by associating tables and descriptions with labels.

In an example embodiment of the current technique, the SQL query generation system performs semantic role analysis to understand roles of different elements in the natural language query with respect to predicate-argument structure.

In an example embodiment of the current technique, the SQL query generation system uses a natural language processing model to separate the natural language query into individual words and punctuation.

In an example embodiment of the current technique, the SQL query generation system classifies each tokenized word as a noun, verb, adjective, or other grammatical category.

In an example embodiment of the current technique, the SQL query generation system recognizes and labels entities including person names, dates, currency values, and duration terms.

In an example embodiment of the current technique, the SQL query generation system performs dependency parsing to determine relationships between words in the query.

In an example embodiment of the current technique, the SQL query generation system analyzes keywords and contextual information to determine if the query involves data retrieval, insertion, deletion, or updates.

In an example embodiment of the current technique, the metadata includes a data dictionary containing fields for table names, column names, descriptions, and relationships.

In an example embodiment of the current technique, the metadata comprises contextual information about data purpose, data usage, data relationships between tables, data source information, and column descriptions.

In an example embodiment of the current technique, the data relationships between tables in the metadata comprise primary and foreign key associations between tables.

In an example embodiment of the current technique, the column descriptions comprise explanations of attribute meanings and purposes.

In an example embodiment of the current technique, the SQL query generation system uses a trained machine learning model to analyze metadata content for table labeling, where the trained machine learning model is trained using manually annotated table-label pairs.

In an example embodiment of the current technique, the SQL query generation system maps semantic roles to SQL query components and applies query generation rules based on the identified intent.

In an example embodiment of the current technique, the query generation rules specify different SQL syntax patterns for different types of user intent.

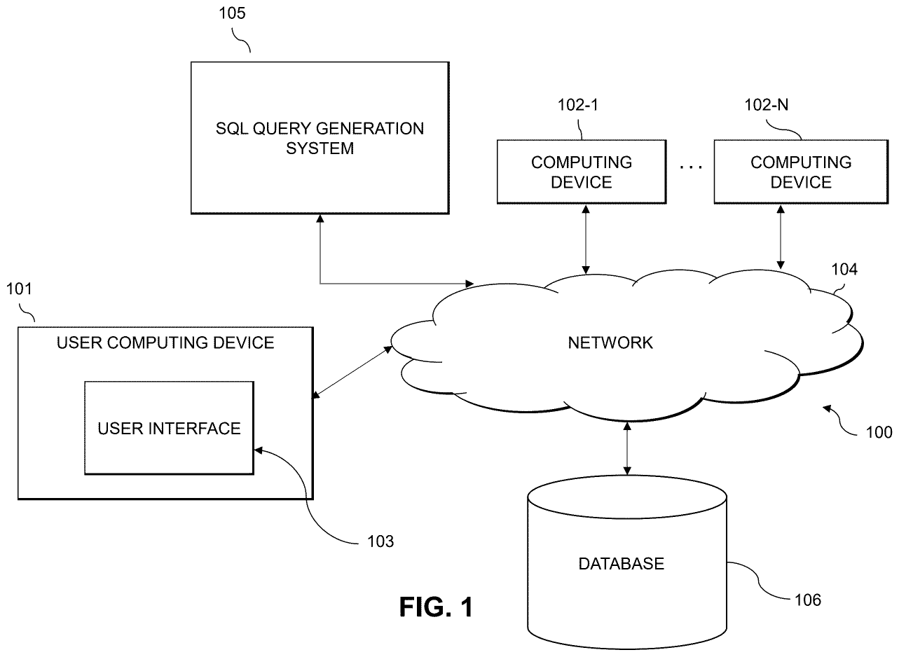

FIG. 1 shows a computer network (also referred to herein as an information processing system) 100 configured in accordance with an illustrative embodiment. The computer network 100 comprises a user computing device 101 comprising a user interface 103, SQL query generation system 105, and computing devices 102-N. The user computing device 101, SQL query generation system 105, and computing devices 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The SQL query generation system 105 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the user computing device 101 and computing device 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user computing device 101 and computing device 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the SQL query generation system 105 are one or more input-output devices, which illustratively comprise keyboards, displays or other types of input-output devices in any combination. Such input-output devices can be used, for example, to support one or more user interfaces to the SQL query generation system 105, as well as to support communication between the SQL query generation system 105 and other related systems and devices not explicitly shown. For example, a dashboard may be provided for a user to view results produced by the SQL query generation system 105. One or more input-output devices may also be associated with any of the user computing device 101 and computing device 102-N.

Additionally, the SQL query generation system 105 in the FIG. 1 embodiment is assumed to be implemented using at least one processing device. Each such processing device generally comprises at least one processor and an associated memory, and implements one or more functional modules for controlling certain features of the SQL query generation system 105.

More particularly, the SQL query generation system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the SQL query generation system 105 to communicate over the network 104 with the user computing device 101 and computing device 102-N and illustratively comprises one or more conventional transceivers.

A SQL query generation system 105 may be implemented at least in part in the form of software that is stored in memory and executed by a processor, and may reside in any processing device. The SQL query generation system 105 may be a standalone plugin that may be included within a processing device.

It is to be understood that the particular set of elements shown in FIG. 1 for SQL query generation system 105 involving the user computing device 101 and computing device 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the SQL query generation system 105 can be on and/or part of the same processing platform.

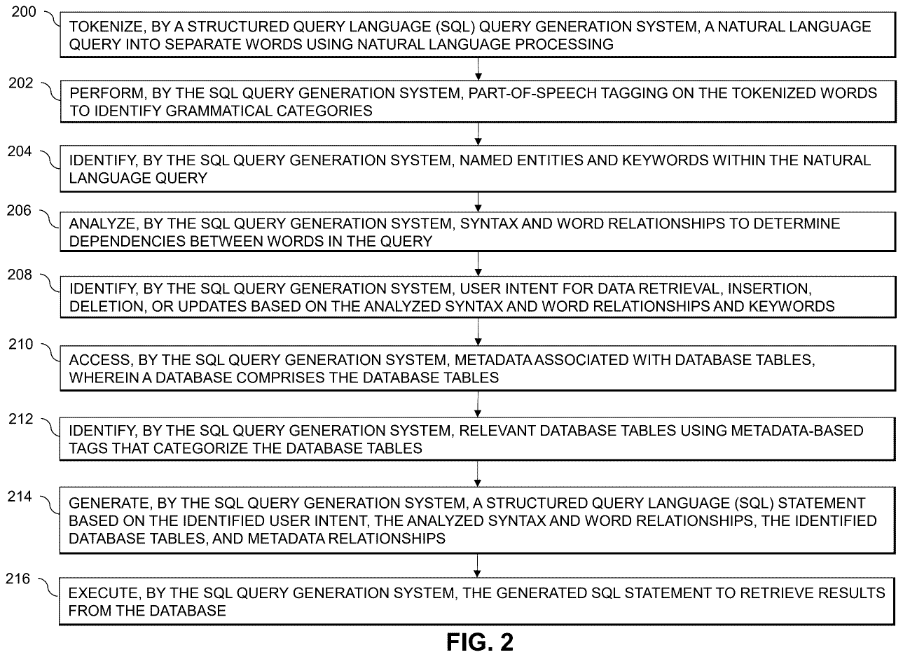

An exemplary process of SQL query generation system 105 in computer network 100 will be described in more detail with reference to, for example, the flow diagram of FIG. 2.

FIG. 2 is a flow diagram of a process for execution of the SQL query generation system 105 in an illustrative embodiment. It is to be understood that this particular process is only an example, and additional or alternative processes can be carried out in other embodiments.

At 200, the SQL query generation system 105 tokenizes a natural language query into separate words using natural language processing. In an example embodiment, the SQL query generation system 105 enables users to describe their data retrieval needs using standard language. In an example embodiment, a user inputs theses data retrieval needs into a user interface 103. In other words, users express their data requirements from the database 106 naturally, without having to struggle with SQL syntax. The SQL query generation system 105, enhanced with natural language processing (NLP) capabilities, converts these data requirement expressions into accurate and efficient SQL queries.

In an example embodiment, the SQL query generation system 105 uses a natural language processing model to separate the natural language query into individual words and punctuation. In other words, the SQL query generation system 105 tokenizes the inputted English sentence into separate words.

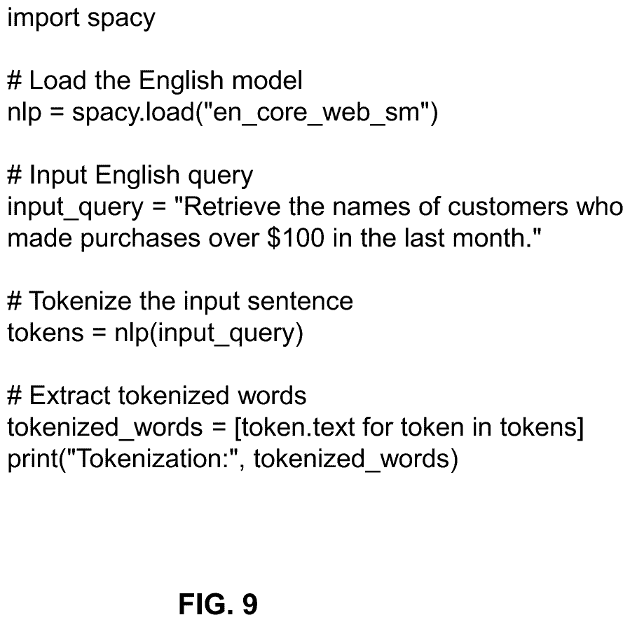

In an example embodiment, the SQL query generation system 105 utilizes the spaCy English model and uses it for NLP tasks such as tokenization, part-of-speech tagging, and named entity recognition. FIG. 9 illustrates example software code that imports a spaCy English model. In an example embodiment, the SQL query generation system 105 receives as input an English query, tokenizes the query into separate words using spaCy, then extracts and prints the tokenized words. For example, the SQL query generation system 105 receives as input a query such as, “Retrieve the names of customers who made purchases over $100 in the last month”. The output of the query is:

Tokenization: [“Retrieve”, “the”, “names”, “of”, “customers”, “who”, “made”,
“purchases”, “over”, “$100”, “in”, “the”, “last”, “month”]

At 202, the SQL query generation system 105 performs part-of-speech tagging on the tokenized words to identify grammatical categories. In an example embodiment, the SQL query generation system 105 assigns grammatical categories to tokens so as to understand their roles in sentences, such as nouns, verbs, adjectives, etc. The SQL query generation system 105 classifies each tokenized word as a noun, verb, adjective, or other grammatical category to understand each token's action. This helps to break down the sentence, extract meaningful information and convert the sentence into a structured representation that can be used to formulate a database query. The SQL query generation system 105 can then take precise and context-aware actions based on the user's input.

In an example embodiment, the SQL query generation system 105 creates additional context and information about the data to improve understanding, facilitate data management, and enhance the usability of the data. The SQL query generation system 105 identifies contextual information about the data's purpose, source, and usage, aiding users in comprehending the importance of each table or dataset. The SQL query generation system 105 identifies data relationships, describing table relationships and interdependencies through primary and foreign key associations to assist users in understanding how the data is connected. The SQL query generation system 105 identifies column descriptions, describing column details, providing explanations for attribute meanings and purposes. The SQL query generation system 105 tracks versioning and changes for users to understand data modification history and details. The SQL query generation system 105 standardizes metadata labels for consistent categorization in the database. The SQL query generation system 105 generates a data dictionary which is a repository for metadata. The data dictionary includes fields for table names, column names, descriptions, relationships, etc.

In an example embodiment, the SQL query generation system 105 creates a metadata framework to categorize and label tables or datasets in a database, to improve data understanding and usability. In an example embodiment, the SQL query generation system 105 assigns categories or labels to database tables to describe their content, example labels include “Customer,” “Order,” and “Product.” The SQL query generation system 105 uses the metadata to identify the type of data in each table. The SQL query generation system 105 annotates training data manually by associating tables and its description with labels/tags, and creates table-label pairs.

The SQL query generation system 105 brings intelligence to the process of tagging database tables by leveraging the metadata. The metadata offers details about the composition, attributes, and structure of the data and therefore, the tables are intelligently categorized and labelled. The metadata includes details about the columns, data types, and content of each table, allowing an understanding of the nature of the data stored in each table. The SQL query generation system 105 then defines categories or labels that represent different types of data present in the tables. The SQL query generation system 105 uses metadata as a guide for associating tables with predefined categories or labels, creating a labeled dataset that the model can learn from.

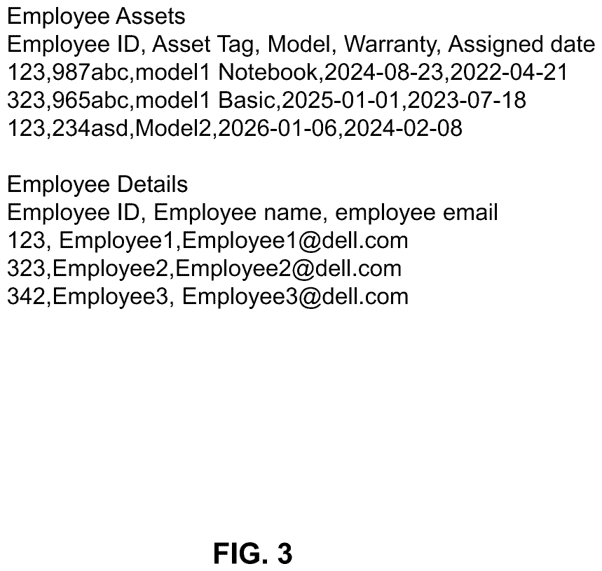

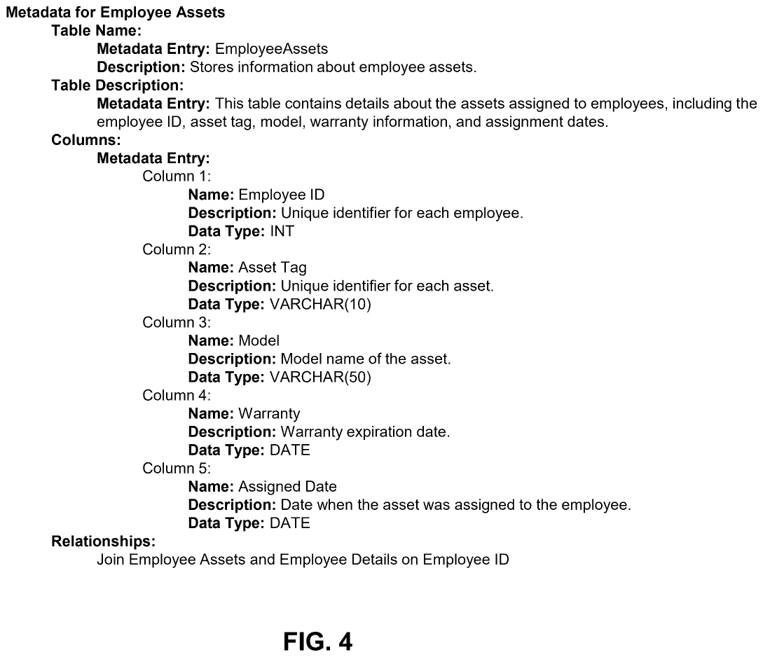

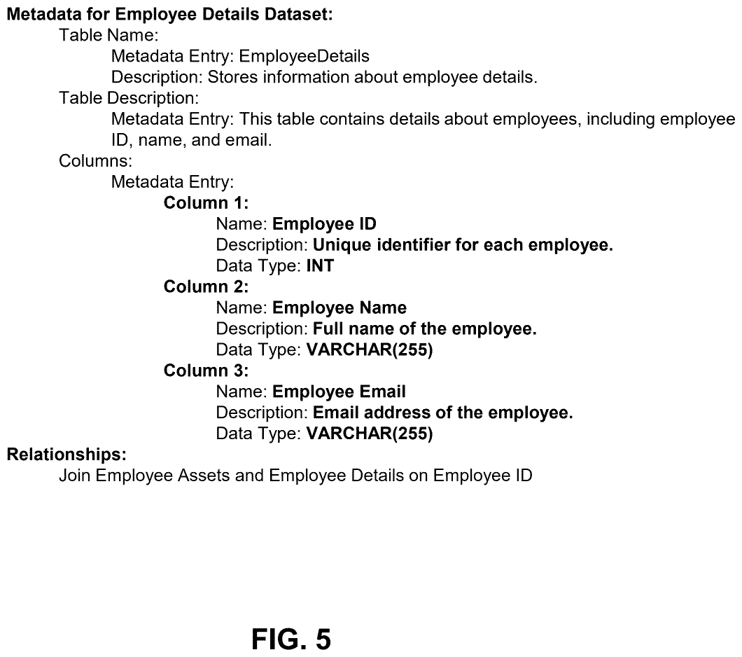

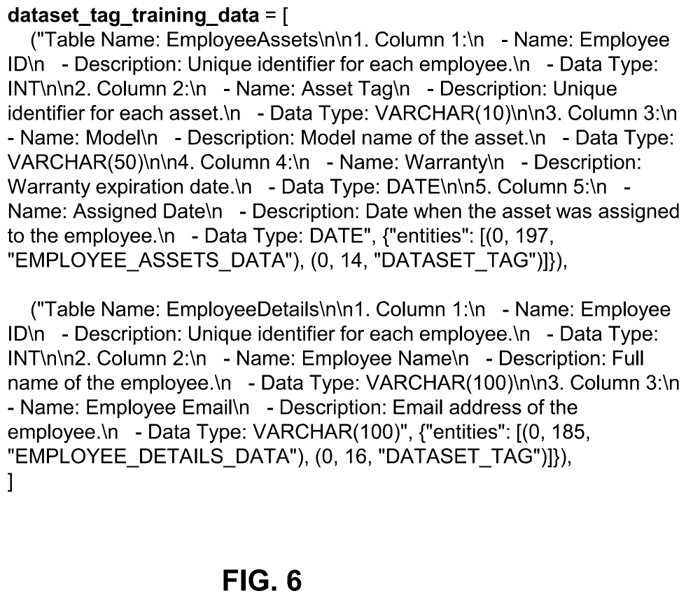

In an example embodiment, the SQL query generation system 105 uses an NLP framework spaCy to train a custom model for table labelling based on metadata content. In an example embodiment, the SQL query generation system 105 creates a model to tag entities based on the provided data sets for both “Employee Assets” and Employee Details” as shown in FIG. 3. FIG. 4 shows the metadata for Employee Assets and FIG. 5 shows the metadata for Employee Details. The SQL query generation system 105 creates annotated training data for both the “Employee Assets” (tagged as EMPLOYEE_ASSETS_DATA) and “Employee Details” (tagged as EMPLOYEE_DETAILS_DATA) datasets as illustrated in FIG. 6.

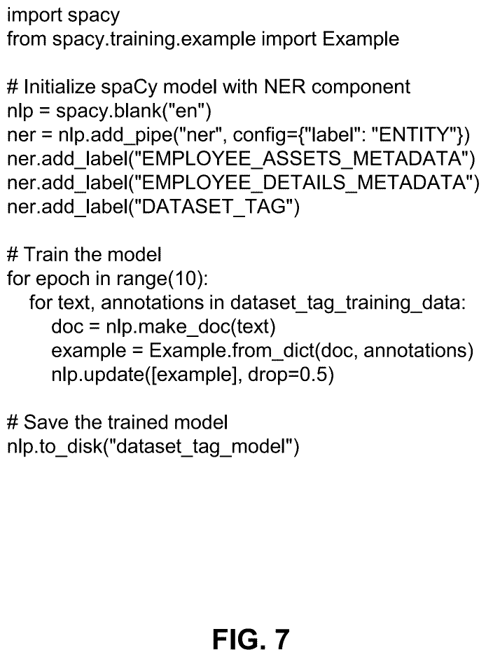

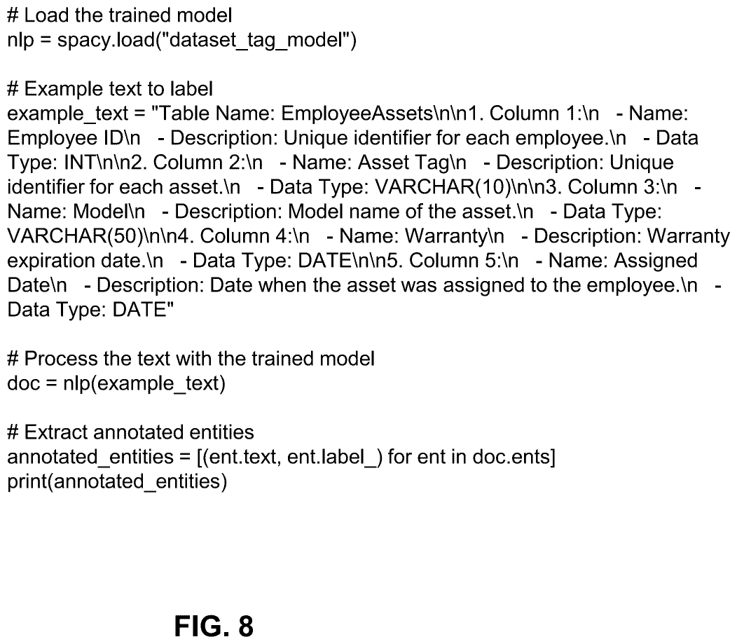

In an example embodiment, the ss trains the spaCy Named Entity Recognition (NER) model using the combined annotated training data as illustrated in FIG. 7. The SQL query generation system 105 uses the trained model to annotate new data and extract the recognized entities as shown in FIG. 8. The SQL query generation system 105 automatically predicts and assigns labels based on content when creating a new table or adding data.

In an example embodiment, the SQL query generation system 105 utilizes the spaCy model to perform the part-of-speech (POS) tagging. The SQL query generation system 105 extracts and prints the part-of-speech tags for each token. An example of POS tagging code is listed below:

# Perform POS tagging
pos_tags = [token.pos_ for token in tokens]
print(“POS Tags:”, pos_tags)

The output is: [Verb, Determiner, Noun, Preposition, Noun, Pronoun, Verb, Noun, Preposition, Currency, Cardinal Number, Preposition, Determiner, Adjective, Noun].

At 204, the SQL query generation system 105 identifies named entities and keywords within the natural language query. For example, this may include a persons' names, purchase, dates, and relevant entities for the query. This information helps to understand the query context. In an example embodiment, the SQL query generation system 105 recognizes and labels entities including person names, dates, currency values, and duration terms. In an example embodiment, the SQL query generation system 105 performs named entity recognition using the spaCy model. The SQL query generation system 105 extracts and prints the named entities along with the labels. An example of named entity recognition code is listed below:

```
  # Perform Named Entity Recognition (NER)
  named_entities = [(ent.text, ent.label_) for ent in tokens.ents]
  print(“Named Entities:”, named_entities)
  The output is: [None, None, Customer (Entity), None, None, None, None, Purchase
(Entity), None, Money (Entity), Date (Entity), None, None, Duration (Entity)].
```

At 206, the SQL query generation system 105 analyzes syntax and word relationships to determine dependencies between words in the query. In an example embodiment, the SQL query generation system 105 analyzes the syntax and word relationships in a sentence to determine dependencies and grammatical relationships, which are necessary for create a meaningful SQL query. In an example embodiment, the SQL query generation system 105 performs dependency parsing using the spaCy model to determine relationships between words in the query. The SQL query generation system 105 extracts and prints the dependences between words in the sentence.

An example of dependency parsing code is listed below:

```
  # Dependency Parsing
  dependencies = [(token.text, token.dep_, token.head.text) for token in tokens]
  print(“Dependencies:”, dependencies)
  The output is: [Retrieve -> names, names -> customers, made -> customers, purchases ->
customers, over -> purchases, $100 -> over, in -> purchases, month -> in]
```

At 208, the SQL query generation system 105 identifies user intent for data retrieval, insertion, deletion, or updates based on the analyzed syntax and word relationships and keywords. In an example embodiment, the SQL query generation system 105 assigns roles to sentence parts, indicating their semantic function in the query, helping to map natural language constructs to SQL query components. In an example embodiment, the SQL query generation system 105 performs semantic role analysis to understand the roles of different elements in a sentence, particularly with respect to the predicate-argument structure.

In an example embodiment, the SQL query generation system 105 analyzes keywords and contextual information to determine if the query involves data retrieval, insertion, deletion, or updates. Using the query, “Retrieve the names of customers who made purchases over $100 in the last month”, the SQL query generation system 105 identifies the primary action (“Retrieve”), the retrieval object (“Customers”), and the purchase and customer-related conditions.

An example of extracting semantic roles code is listed below.

# Extracting semantic roles
semantic_roles = [(token.text, token.dep_, token.head.text) for token in tokens]
print(“Semantic Roles:”, semantic_roles)

The output is:
Retrieve—Predicate: Retrieve
names—Argument 0: Names
of—Preposition: Of
customers—Argument 1: Customers
who—Relative Clause Modifier: Who
made—Predicate: Made
purchases—Argument 2: Purchases
over—Prep: Over
$100—Argument 3: $100
in—Prep: In
the—Determiner: The
last—Modifier: Last
month—Argument 4: Month

In an example embodiment, the SQL query generation system 105 identifies the user's query intent, such as data retrieval, insertion, deletion, or updates. The SQL query generation system 105 also recognizes the key conditions and criteria mentioned in the query. In an example embodiment, the SQL query generation system 105 combines observations to creates rules and conditions that infer the user intent based on keywords, contextual information, and the structure of the query. In an example embodiment, the observations may include examples such as the presence of the word “Retrieve” suggests an intention to retrieve information from the database, the query mentions specific information to be retrieved (“names of customers”), and/or the criteria for retrieval are also specified (“who made purchases over $100 in the last month”).

In an example embodiment, the SQL query generation system 105 analyzes the syntactic structure and semantic roles assigned by the spaCy model to understand the main actions and entities involved. An example of code that analyzes user intent is listed below:

```
# Analyzing user intent based on keywords
if “Retrieve” in tokenized_words:
  user_intent = “data retrieval”
else:
  user_intent = “unknown”
print(“User Intent:”, user_intent)
Output: [ Intent: data retrieval]
```

At 210, the SQL query generation system 105 accesses metadata associated with database tables, where the database 106 comprises the database tables. In an example embodiment, the metadata comprises contextual information about data purpose, data usage, data relationships between tables, data source information, and column descriptions. In an example embodiment, the metadata includes a data dictionary containing fields for table names, column names, descriptions, and relationships. In an example embodiment, the data relationships between tables in the metadata comprise primary and foreign key associations between tables. In an example embodiment, the column descriptions comprise explanations of attribute meanings and purposes.

At 212, the SQL query generation system 105 identifies relevant database tables using metadata-based tags that categorize the database tables. The tags are used to identify and categorize datasets. This allows the users to specify which datasets they want to query/merge with the help of the metadata relationships. This helps with managing and interacting with various datasets in a structured manner. In an example embodiment, the SQL query generation system 105 uses a trained machine learning model to analyze metadata content for table labeling, where the trained machine learning model is trained using manually annotated table-label pairs.

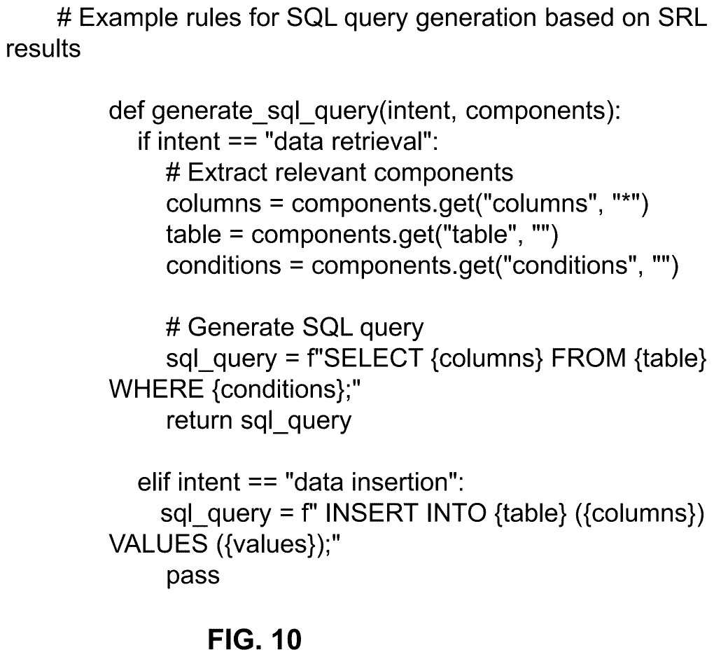

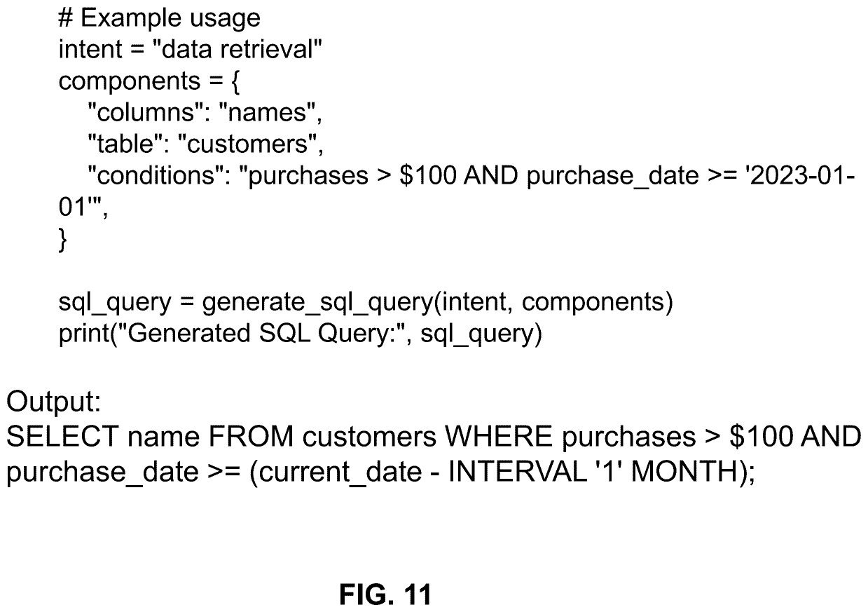

At 214, the SQL query generation system 105 generates a structured query language (SQL) statement based on the identified user intent, the analyzed syntax and word relationships, the identified database tables, and metadata relationships. In an example embodiment, the SQL query generation system 105 constructs SQL queries by using rules based on identified user intent, conditions, and semantic roles. In an example embodiment, the SQL query generation system 105 maps semantic roles to SQL query components and applies query generation rules based on the identified intent. In an example embodiment, the query generation rules specify different SQL syntax patterns for different types of user intent. In an example embodiment, the SQL query generation system 105 utilizes the identified user intent and mapped components to generate SQL queries and combine the mapped components to form a valid SQL query. For example, using the query, “Retrieve the names of customers who made purchases over $100 in the last month”, the identified user intent is data retrieval. The SQL query generation system 105 uses the following syntax, “SELECT <columns> FROM <table> WHERE <conditions>”. If the identified user intent is data insertion, the SQL query generation system 105 uses the following syntax, “INSERT INTO <table> (<columns>) VALUES (<values>)”. FIG. 10 illustrates example code for SQL query generation based on the results of the semantic role analysis. FIG. 11 illustrates an example usage of the code from FIG. 10, and the output SQL query generated by the SQL query generation system 105.

At 216, the SQL query generation system 105 executes the generated SQL statement to retrieve results from the database 106. The SQL query generation system 105 receives as input a sentence generated by a user, “Retrieve the names of customers who made purchases over $100 in the last month”, and the SQL query generation system 105 generates the SQL query, “SELECT name FROM customers WHERE purchases>$100 AND purchase_date>=(current_date−INTERVAL ‘1’ MONTH)”. In other words, the users can express their data retrieval requirements in simple English, and the SQL query generation system 105 will automatically convert those retrieval requirements into a valid SQL query, execute the query and retrieve the results. In an example embodiment, a user enters the sentence “Retrieve the names of customers who made purchases over $100 in the last month” into the user interface 103, and the results of the SQL query (“SELECT name FROM customers WHERE purchases>$100 AND purchase_date>=(current_date-INTERVAL ‘1’ MONTH)”) generated by the SQL query generation system 105 is outputted on the user interface 103.

The above-described illustrative embodiments provide significant advantages relative to conventional approaches. For example, some embodiments are configured to significantly improve SQL query generation by automatically translating simple language requirements into efficient SQL queries for data retrieval from databases. These and other embodiments can effectively improve the experience of users interacting with data sets in databases. Embodiments disclosed herein provide a user-friendly interface that allows non-technical users to interact with specific datasets, using various database operations. Embodiments disclosed herein enable diverse employees to interact with databases to diversity the workforce, reducing reliance on a small, specialized group. Embodiments disclosed herein provide metadata-driven query generation to enable flexibility in adapting to changes in database structures, enabling users to interact with database tables based on the associated metadata. Embodiments disclosed herein combine natural language with SQL translation, generating queries based on metadata and using tags to identify datasets. Embodiments disclosed herein provide a system that bridges the gap between technical and non-technical users, making data extraction more user-friendly and efficient.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

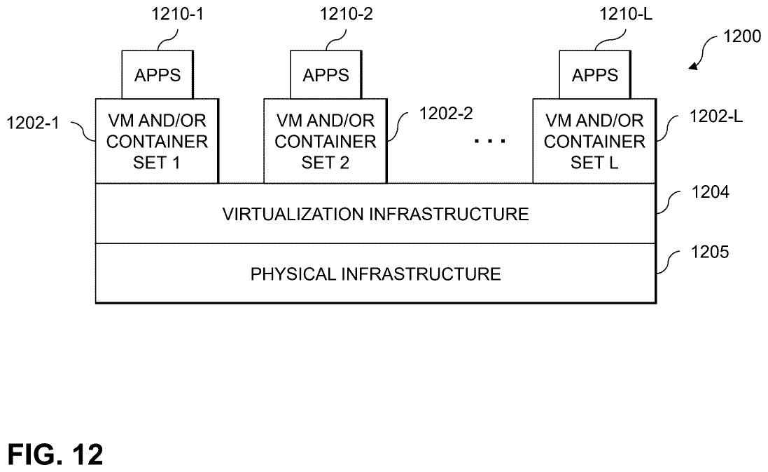

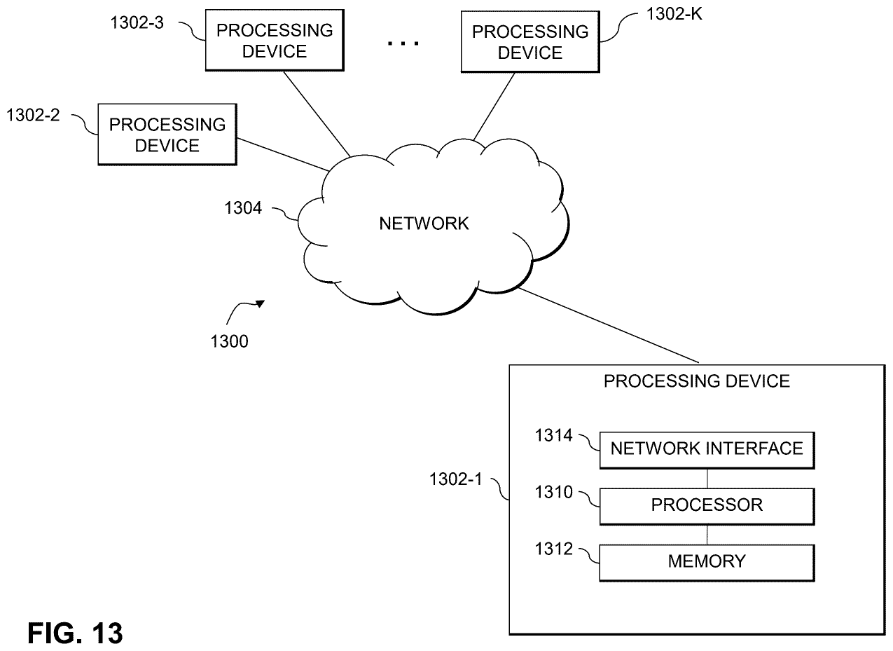

Illustrative embodiments of processing platforms will now be described in greater detail with reference to FIGS. 12 and 13. Although described in the context of the information processing system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that are utilized to implement at least a portion of the information processing system 100. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 comprise respective VMs, respective sets of one or more containers, or respective sets of one or more containers running in VMs. In some implementations of the FIG. 12 embodiment, the VMs/container sets 1202 comprise respective VMs implemented using virtualization infrastructure 1204 that comprises at least one hypervisor.

A hypervisor platform may be used to implement a hypervisor within the virtualization infrastructure 1204, where the hypervisor platform has an associated virtual infrastructure management system. The underlying physical machines comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of the information processing system 100 and includes a plurality of processing devices, denoted 1302-1, 1302-2, 1302-3, . . . 1302-K, which communicate with one another over a network 1304.

The network 1304 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1302-1 in the processing platform 1300 comprises a processor 1310 coupled to a memory 1312.

The processor 1310 comprises a microprocessor, a microcontroller, an application-specific integrated circuit (ASIC), a field-programmable gate array (FPGA) or other type of processing circuitry, as well as portions or combinations of such circuitry elements.

The memory 1312 comprises random access memory (RAM), read-only memory (ROM) or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
tokenizing, by a structured query language (SQL) query generation system, a natural language query into separate words using natural language processing;
performing, by the SQL query generation system, part-of-speech tagging on the tokenized words to identify grammatical categories;
identifying, by the SQL query generation system, named entities and keywords within the natural language query;
analyzing, by the SQL query generation system, syntax and word relationships to determine dependencies between words in the query;
identifying, by the SQL query generation system, user intent for data retrieval, insertion, deletion, or updates based on the analyzed syntax and word relationships and keywords;
accessing, by the SQL query generation system, metadata associated with database tables, wherein a database comprises the database tables, wherein the metadata comprises a metadata framework comprising metadata-based tags organized to assign category labels to the database tables based on table content;
identifying, by the SQL query generation system, relevant database tables using the metadata-based tags that categorize the database tables, wherein identifying the relevant database tables comprises using a trained machine learning model to analyze metadata content for table labeling, and wherein the trained machine learning model is trained using manually annotated table-label pairs that associate tables with descriptive labels;
generating, by the SQL query generation system, a structured query language (SQL) statement based on the identified user intent, the analyzed syntax and word relationships, the identified database tables, and metadata relationships; and
executing, by the SQL query generation system, the generated SQL statement to retrieve results from the database, wherein the method is implemented by at least one processing device comprising a processor coupled to a memory.

2. The method of claim 1 further comprising tracking versioning and changes in the metadata to maintain data modification history.

3. The method of claim 1 further comprising automatically predicting and assigning the category labels to new tables based on content associated with the new tables using the trained machine learning model.

4. The method of claim 1 further comprising standardizing the metadata labels in the metadata framework for consistent categorization in the database.

5. The method of claim 1 further comprising creating annotated training data by associating tables and descriptions with labels to train the trained machine learning model for table labeling.

6. The method of claim 1 further comprising performing semantic role analysis to understand roles of different elements in the natural language query with respect to predicate-argument structure.

7. The method of claim 1 wherein tokenizing the natural language query comprises:
using a natural language processing model to separate the natural language query into individual words and punctuation.

8. The method of claim 1 wherein performing the part-of-speech tagging comprises:
classifying each tokenized word as a noun, verb, adjective, or other grammatical category.

9. The method of claim 1 wherein identifying the named entities comprises:
recognizing and labeling entities including person names, dates, currency values, and duration terms.

10. The method of claim 1 wherein analyzing the syntax and word relationships comprises:
performing dependency parsing to determine relationships between words in the query.

11. The method of claim 1 wherein identifying the user intent comprises:
analyzing keywords and contextual information to determine if the query involves data retrieval, insertion, deletion, or updates.

12. The method of claim 1 wherein the metadata includes a data dictionary containing fields for table names, column names, descriptions, and relationships.

13. The method of claim 1 wherein the metadata comprises contextual information about data purpose, data usage, data relationships between tables, data source information, and column descriptions.

14. The method of claim 13 wherein the data relationships between tables in the metadata comprise primary and foreign key associations between tables.

15. The method of claim 13 wherein the column descriptions comprise explanations of attribute meanings and purposes.

16. The method of claim 1 wherein identifying the relevant database tables comprises:
using a trained machine learning model to analyze metadata content for table labeling, wherein the trained machine learning model is trained using manually annotated table-label pairs that associate database tables with category labels based on table content and metadata descriptions.

17. The method of claim 1 wherein generating the SQL statement comprises:
mapping semantic roles to SQL query components; and
applying query generation rules based on the identified intent.

18. The method of claim 17 wherein the query generation rules specify different SQL syntax patterns for different types of user intent.

19. A computer program product comprising a non-transitory processor-readable storage medium having stored therein program code of one or more software programs, wherein the program code when executed by at least one processing device causes said at least one processing device:
to tokenize, by a structured query language (SQL) query generation system, a natural language query into separate words using natural language processing;
to perform, by the SQL query generation system, part-of-speech tagging on the tokenized words to identify grammatical categories;
to identify, by the SQL query generation system, named entities and keywords within the natural language query;
to analyze, by the SQL query generation system, syntax and word relationships to determine dependencies between words in the query;
to identify, by the SQL query generation system, user intent for data retrieval, insertion, deletion, or updates based on the analyzed syntax and word relationships and keywords;
to access, by the SQL query generation system, metadata associated with database tables, wherein a database comprises the database tables, wherein the metadata comprises a metadata framework comprising metadata-based tags organized to assign category labels to the database tables based on table content;
to identify, by the SQL query generation system, relevant database tables using metadata-based tags that categorize the database tables, wherein identifying the relevant database tables comprises using a trained machine learning model to analyze metadata content for table labeling, and wherein the trained machine learning model is trained using manually annotated table-label pairs that associate tables with descriptive labels;
to generate, by the SQL query generation system, a structured query language (SQL) statement based on the identified user intent, the analyzed syntax and word relationships, the identified database tables, and metadata relationships; and
to execute, by the SQL query generation system, the generated SQL statement to retrieve results from the database.

20. A system comprising:
at least one processing device comprising a processor coupled to a memory;
the at least one processing device being configured:
to tokenize, by a structured query language (SQL) query generation system, a natural language query into separate words using natural language processing;
to perform, by the SQL query generation system, part-of-speech tagging on the tokenized words to identify grammatical categories;
to identify, by the SQL query generation system, named entities and keywords within the natural language query;
to analyze, by the SQL query generation system, syntax and word relationships to determine dependencies between words in the query;
to identify, by the SQL query generation system, user intent for data retrieval, insertion, deletion, or updates based on the analyzed syntax and word relationships and keywords;
to access, by the SQL query generation system, metadata associated with database tables, wherein a database comprises the database tables, wherein the metadata comprises a metadata framework comprising metadata-based tags organized to assign category labels to the database tables based on table content;
to identify, by the SQL query generation system, relevant database tables using metadata-based tags that categorize the database tables, wherein identifying the relevant database tables comprises using a trained machine learning model to analyze metadata content for table labeling, and wherein the trained machine learning model is trained using manually annotated table-label pairs that associate tables with descriptive labels;
to generate, by the SQL query generation system, a structured query language (SQL) statement based on the identified user intent, the analyzed syntax and word relationships, the identified database tables, and metadata relationships; and
to execute, by the SQL query generation system, the generated SQL statement to retrieve results from the database.
